(19) United States
(12) Patent Application Publication
(10) Pub. No.: US 2007/0144523 A1
(43) Pub. Date: Jun. 28, 2007

(54) Mri/nmr compatible hyperpolarized gas delivery valves for ventilators and associated gas delivery methods

(76) Inventors: Kenneth Bolam, Cary, NC (US); James Davidson, Flagstaff, AZ (US); James Borgen, Cary, NC (US)

Correspondence Address: GE HEALTHCARE, INC., IP DEPARTMENT, 101 CARNEGIE CENTER, PRINCETON, NJ, 08540-6231, US

(21) Appl. No.: 10/547,436

(22) PCT Filed: Feb. 25, 2004
(86) PCT No.: PCT/US04/05567

§ 371 Date: Aug. 18, 2006

Related U.S. Application Data
(60) Provisional application No. 60/450,209, filed on Feb. 26, 2003.

(51) Int. Cl. A62B 9/02

(52) U.S. Cl. 128/205.24; 128/204.18

(57) ABSTRACT

Methods, systems, assemblies, computer program products and devices deliver hyperpolarized gas by: (a) providing a gas delivery valve with at least one gas flow path therein, the valve comprising a valve body and at least one spool held in the valve body; (b) transmitting a pilot command fluid pulse signal to the at least one spool to introduce pressure onto the spool to force the spool to translate an actuation distance in the valve body; and (c) opening and/or closing the at least one gas flow path in response to the transmitted signal to deliver hyperpolarized gas to a subject.

### FIELD OF THE INVENTION

The present invention relates to the delivery of polarized noble gases to subjects for evaluations using NMR spectroscopy and/or magnetic resonance imaging (“MRI”).

### BACKGROUND OF THE INVENTION

Polarized inert noble gases can produce improved MRI images of certain areas and regions of the body that have heretofore produced less than satisfactory images in this modality. Polarized helium-3 (“³He”) and xenon-129 (“¹²⁹Xe”) have been found to be particularly suited for this purpose. Unfortunately, the polarized state of the gases is sensitive to handling and environmental conditions and can, undesirably, decay from the polarized state relatively quickly.

Hyperpolarizers are used to produce and accumulate polarized noble gases. Hyperpolarizers artificially enhance the polarization of certain noble gas nuclei (such as ¹²⁹Xe or ³He) over the natural or equilibrium levels, i.e., the Boltzmann polarization. Such an increase is desirable because it enhances and increases the MRI signal intensity, allowing physicians to obtain better images of the substance in the body. See U.S. Pat. Nos. 5,545,396; 5,642,625; 5,809,801; 6,079,213, and 6,295,834; the disclosures of these patents are hereby incorporated by reference herein as if recited in full herein.

In order to produce the hyperpolarized gas, the noble gas is typically blended with optically pumped alkali metal vapors such as rubidium (“Rb”). These optically pumped metal vapors collide with the nuclei of the noble gas and hyperpolarize the noble gas through a phenomenon known as “spin-exchange.” The “optical pumping” of the alkali metal vapor is produced by irradiating the alkali-metal vapor with circularly polarized light at the wavelength of the first principal resonance for the alkali metal (e.g., 795 nm for Rb). Generally stated, the ground state atoms become excited, then subsequently decay back to the ground state. Under a modest magnetic field (10 Gauss), the cycling of atoms between the ground and excited states can yield nearly 100% polarization of the atoms in a few microseconds. This polarization is generally carried by the lone valence electron characteristics of the alkali metal. In the presence of non-zero nuclear spin noble gases, the alkali-metal vapor atoms can collide with the noble gas atoms in a manner in which the polarization of the valence electrons is transferred to the noble-gas nuclei through a mutual spin flip “spin-exchange.” After the spin-exchange has been completed, the hyperpolarized gas is typically separated from the alkali metal prior to administration to a patient (to form a non-toxic pharmaceutically acceptable product). Unfortunately, during production and/or during and after collection, the hyperpolarized gas can deteriorate or decay relatively quickly (lose its hyperpolarized state) and therefore must be handled, collected, transported, and stored carefully.

In the past, several researchers have used hyperpolarized gas compatible ventilators for delivering polarized gas to subjects to image hyperpolarized noble gases such as helium and xenon. For example, Hedlund et al., in MR-compatible ventilator for small animals; computer controlled ventilation for proton and noble gas imaging, 18 Magnetic Resonance Imaging, pp. 753-759 (2000), state that ventilators have been in routine use in their laboratory for a number of years. See also, Hedlund et al., Three-dimensional MR microscopy of pulmonary dynamics, Society of Magnetic Resonance (New York, N.Y., 1996); and a poster presented by Hedlund et al. at the Amer. Thoracic Society 1998 International Meeting (Chicago, 1998), entitled MRI of pulmonary airways with hyperpolarized helium; a computer-controlled ventilator for imaging synchronous gas delivery in animal studies (describing ventilator technology). In addition, Black and co-workers have used a hyperpolarized gas-compatible ventilator to generate what is believed to be the first ever in vivo images of hyperpolarized ³He in guinea pig lungs. See Black et al., In vivo He-3MR images of guinea pig lungs, Radiology, 199(3), pp. 867-870 (1996). Unfortunately, the valves used to control the delivery of the polarized gases have, in the past, been limited by one or more of slow response times, relatively limited flow rates, and/or limited respiration rates (about 120 breaths per minute (BPM)).

Despite the foregoing, there remains a need to provide improved valve configurations for ventilation delivery of hyperpolarized gas.

### SUMMARY OF THE INVENTION

Embodiments of the present invention can provide improved MRI compatible hyperpolarized gas delivery valves that employ spool configurations.

In particular embodiments, the valve configuration uses multiple spools to controllably sequentially deliver for inhalation, a plurality of gases, such as a hyperpolarized gas and a non-polarized gas to a subject. The multiple-spool valve can be configured to controllably select between three or more different flow paths that allow for inhale, exhale, and breath-hold flow paths as well as delivery of different gas formulations.

In operation, the spool valve configuration can employ a command pilot gas signal with a pressure of between about 30-60 psi. In addition, the spool valves can be configured to react to the pilot pressure in a relatively short response time, such as in under about 50 ms, and typically in about 40 ms (which is less than about half the response time of diaphragm type valves) to alter the valve flow path to transmit the desired gas to the subject. In certain embodiments, the valve is configured to operate with a respiration or breath rate (breaths per minute or “BPM”) of at least 150 BPM, typically up to at least 180 BPM, and in certain embodiments about 200 BPM or more. Thus, in certain embodiments, the gas delivery valve can provide a fast response time for a high BPM with a low inhale/exhale ratio.

The gas delivery valves using at least one spool to actuate at least one gas flow path in a valve body may be particularly suitable for small animal ventilators used during NMR spectroscopy and/or MRI imaging sessions. The gas delivery valves can provide fast response times, which may be particularly suitable for use in situations where the subject is ventilated at a high BPM breathing rate with a low inhale/exhale ratio (I/E). The I/E ratio is the inspiration time over the expiration time, inspiration is the time during which the gas is provided to the animal (or other subject) while expiration is the time during which the animal (or other subject) is exhaling. Therefore, a high BPM, such as about 180 BPM, means that each breath lasts 333 ms. An I/E of 20/80 means that the device has 67 ms to deliver the desired tidal volume to the animal (or other subject). The speed at which the valve opens can be important, the faster the BPM, the shorter the I%, and the less time the valve has to open and supply the desired amount of gas to the animal (or other subject).

The I/E ratio is typically within about 30/70 to 60/40, but can vary outside of this range, depending on the desired result. The I/E ratio and BPM can be substantially fixed during “normal” (non-imaging) breathing. The BPM and I/E ratio can be adjusted to be different for imaging (hyperpolarized gas) breath runs, but once the image run is over, these operating parameters can return to “normal” breathing parameters.

Also, it is noted that 180 BPM may be an upper range for many small animal species and, in certain embodiments, the ventilator may operate at a lower rate. The operating parameters are animal species/weight driven. For example, mice use a faster BPM than a rabbit. The I/E ratio can change between animals but will typically stay within the range mentioned above.

The gas delivery valve for a ventilator is configured to supply hyperpolarized gas to a subject and includes: (a) a valve body having at least one gas flow path extending between at least one gas inlet port and at least one gas exit port and at least one spool receptacle (or bore), one of the at least one gas inlet ports being in fluid communication with a hyperpolarized gas source; (b) at least one spool member disposed in a respective one of said at least one spool receptacles of said valve body, said spool member configured and sized to cooperate with said valve body to selectively open and close the at least one gas flow path; and (c) at least one pilot fluid port in fluid communication with said spool receptacle. In operation, a pilot fluid command pulse signal having an associated pressure and duration is transmitted into said pilot fluid port forcing said spool to translate an actuation distance in a predetermined direction in said valve body receptacle to thereby open and/or close the at least one gas flow path.

Other embodiments of the present invention are directed to methods for delivering hyperpolarized gas for inhalation by a subject. The methods include: (a) providing a gas delivery valve with at least one gas flow path therein, the valve comprising a valve body and at least one spool held in the valve body; (b) transmitting a pilot command fluid pulse signal to the at least one spool to introduce pressure onto the spool to force the spool to translate an actuation distance in the valve body; and (c) opening and/or closing the at least one gas flow path in response to the transmitted signal to deliver hyperpolarized gas to a subject.

Other embodiments are directed to computer program products for delivering hyperpolarized gas using a ventilator and an associated gas delivery valve. The gas delivery valve defines a plurality of selectable gas flow paths using a plurality of individually actuatable spools held in the valve, each spool positioned in the valve so that it is in fluid communication with at least one respective pilot gas port. The computer program product includes a computer readable storage medium having computer readable program code embodied in the medium. The computer-readable program code includes: (a) computer readable program code that determines which gas formulation is to be delivered by the gas delivery valve for inhalation by the subject, the gas selection includes at least one hyperpolarized gas, at least one non-polarized gas, and a combined hyperpolarized gas and non-polarized gas mixture; (b) computer readable program code that determines whether to configure the gas delivery valve for inhale, exhale, or breath hold operation; and (c) computer readable program code that transmits a pilot command pulse signal to each spool to actuate the respective spool to a desired operative position in the valve body to thereby open and/or close the desired gas flow paths and deliver the desired gas therethrough.

Other embodiments are directed to an apparatus for delivering hyperpolarized gas to a ventilated subject undergoing NMR spectroscopic and/or MRI evaluation. The apparatus includes: (a) a gas delivery valve with at least one gas flow path therein, the valve comprising a valve body and at least one spool held in the valve body; (b) means for transmitting a pilot command fluid pulse signal to the at least one spool to introduce pressure onto the spool to force the spool to translate an actuation distance in the valve body; and (c) means for opening and/or closing the at least one gas flow path based on the position of the spool in the valve body in response to the transmitted signal to deliver hyperpolarized gas to a subject.

In certain embodiments, the present invention can provide relatively quick actuation of a double acting spool using a single pulse of pilot air to actuate the spool(s) in the valve, allowing the pilot pressure to then be released in between alternating pulses of pilot air to toggle from inhale to exhale. The spool can be actuated during the rising (initial portion) of the pressure response profile or curve. All or selected operations, functions and/or configurations of the embodiments described above with may be carried out as methods, systems, computer program products, assemblies and/or devices as contemplated by the present invention.

The foregoing and other objects and aspects of the present invention are explained in detail herein.

### BRIEF DESCRIPTION OF THE DRAWINGS

FIG. 1 is a block diagram of operations that can be carried out according to embodiments of the present invention.

FIGS. 2A and 2B are schematic views of a spool valve configured to operate in response to pilot gas to define a respective one of two selectable gas flow paths according to embodiments of the present invention.

FIG. 3 is a cutaway view of a gas delivery valve with multiple spools according to embodiments of the present invention.

FIGS. 4A-4H are schematic illustrations of different valve positions of a three-spool valve configuration according to embodiments of the present invention.

FIG. 5 depicts three spool components of the present invention.

FIGS. 6A-6C are schematic illustrations of a prior art gas delivery valve using a diaphragm configuration.

FIG. 7 is a graph of pressure as a function of time (ms) illustrating the response of a diaphragm configuration for a prior art gas delivery valve.

FIG. 8 is a graph of pressure versus time (ms) of the response of a toggle spool valve according to embodiments of the present invention.

FIG. 9 is a block diagram of a system for controlling the sequence of operations for delivering hyperpolarized gas using a hyperpolarized gas delivery valve having a spool design suitable for NMR/MRI applications according to embodiments of the present invention.

### DETAILED DESCRIPTION OF EMBODIMENTS OF THE INVENTION

The present invention will now be described more fully hereinafter with reference to the accompanying figures, in which preferred embodiments of the invention are shown. This invention may, however, be embodied in many different forms and should not be construed as limited to the embodiments set forth herein. Like numbers refer to like elements throughout. In the drawings, layers, regions, or components may be exaggerated for clarity. In the figures, broken lines indicate optional features unless described otherwise.

In the description of the present invention that follows, certain terms may be employed to refer to the positional relationship of certain structures relative to other structures. As used herein the term “forward” and derivatives thereof refer to the general direction the target gas or target gas mixture travels as it moves through the hyperpolarizer system; this term is meant to be synonymous with the term “downstream,” which is often used in manufacturing environments to indicate that certain material being acted upon is farther along in the manufacturing process than other material. Conversely, the terms “rearward” and “upstream” and derivatives thereof refer to the directions opposite, respectively, the forward and downstream directions.

Also, as described herein, polarized gases are produced and collected and may, in particular embodiments be frozen, thawed, used alone and/or combined with other constituents, for MRI and/or NMR spectroscopy applications. For ease of description, the term “frozen polarized gas” means that the polarized gas has been frozen into a solid state. The term “liquid polarized gas” means that the polarized gas has been or is being liquefied into a liquid state. Thus, although each term includes the word “gas,” this word is used to name and descriptively track the gas that is produced via a hyperpolarizer to obtain a polarized “gas” product. Thus, as used herein, the term “gas” or “target gas” has been used in certain places to descriptively indicate a hyperpolarized noble gas product and may be used with modifiers such as “solid”, “frozen”, and “liquid” to describe the state or phase of that product. As also used herein, the term “polarized gas” includes at least one polarized gas of interest (such as, but not limited to, ³He and/or ¹²⁹Xe) and may include one or more other constituents such as other carrier, blending or buffer gases. Further, the terms “polarize”, “polarizer”, “polarized”, and the like are used interchangeably with the terms “hyperpolarize”, “hyperpolarizer”, “hyperpolarized” and the like.

The gas delivery valves contemplated by the present invention can be used for any ventilator systems for target subjects and are hyperpolarized gas-compatible for NMR and/or MRI procedures. “Subjects”, according to the present invention, can be any animal subject, and are preferably mammalian subjects (e.g., humans, canines, felines, bovines, caprines, ovines, equines, rodents, porcines, and/or lagomorphs). The term “small animals” includes mice, rats, guinea pigs, dogs, cats, monkeys, pigs, and rabbits.

Various techniques have been employed to accumulate and capture polarized gases. For example, U.S. Pat. No. 5,642,625 to Cates et al. describes a high volume hyperpolarizer for spin-exchange polarized noble gas and U.S. Pat. No. 5,809,801 to Cates et al. describes a cryogenic accumulator for spin-polarized ¹²⁹Xe. As used herein, the terms “hyperpolarize,” “polarize,” and the like, are used interchangeably and mean to artificially enhance the polarization of certain noble gas nuclei over the natural or equilibrium levels. Such an increase is desirable because it allows stronger imaging signals corresponding to better NMR spectroscopy and/or MRI images of the substance and a targeted area of the body. As is known by those of skill in the art, hyperpolarization can be induced by spin-exchange with an optically pumped alkali-metal vapor or alternatively by metastability exchange. See Albert et al., U.S. Pat. No. 5,545,396.

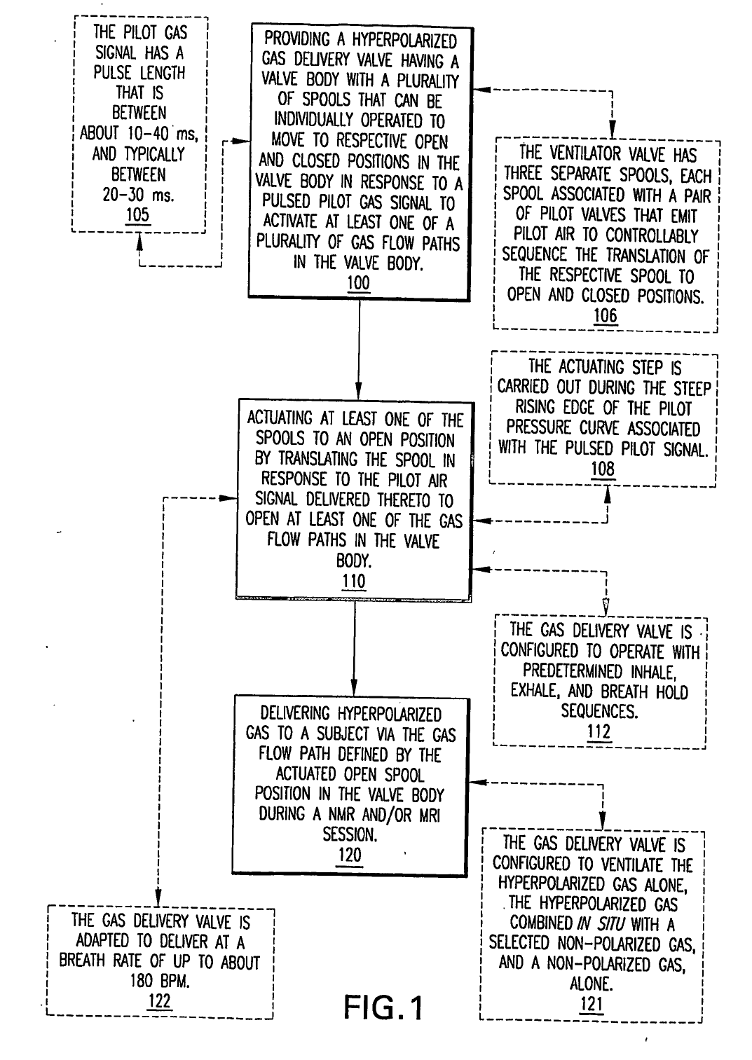

Turning now to FIG. 1, a hyperpolarized gas delivery valve having a valve body with a plurality of spools and a plurality of selectable gas flow paths is provided (block 100). The spools are disposed in the valve body to be in fluid communication with the gas flow paths. The spools can be individually operated to move to respective open positions in the valve body in response to a pulse gas (typically air) signal to selectively activate (and/or deactivate) at least one of a plurality of gas flow paths. The plurality of gas flow paths can be actuated by directing the pulse pilot gas to cause a respective spool to translate between open and closed positions to thereby open and close gas flow paths (block 110). Hyperpolarized gas is delivered to a subject during a NMR and/or MRI session or procedure via the gas flow path(s) defined by the spool positions in the valve body (block 120).

In certain embodiments, the pilot gas signal can have a pulse length between about 10-40 ms, and typically between about 20-30 ms (block 105). The pilot gas signal can be provided as a gas stream having a pressure between about 30-60 psi. The gas delivery valve can be configured to operate with predetermined inhale, exhale, and breath-hold sequences (block 112). The gas delivery valve can be configured to ventilate hyperpolarized gas alone, hyperpolarized gas combined in situ with a selected non-polarized gas, and a non-polarized gas alone. The in situ combination can be caused by the positions of the spools in the valve body. The spools can be actuated by the steep rising edge of the pilot pressure curve associated with the pulsed pilot gas signal (block 108). The gas delivery valve may be adapted to accommodate or deliver at a breath rate of at least 150 BPM, typically up to at least up to about 180 BPM (block 122). In certain embodiments, the gas delivery valve may accommodate a breath rate of at least about 200 BPM (peak inspiration).

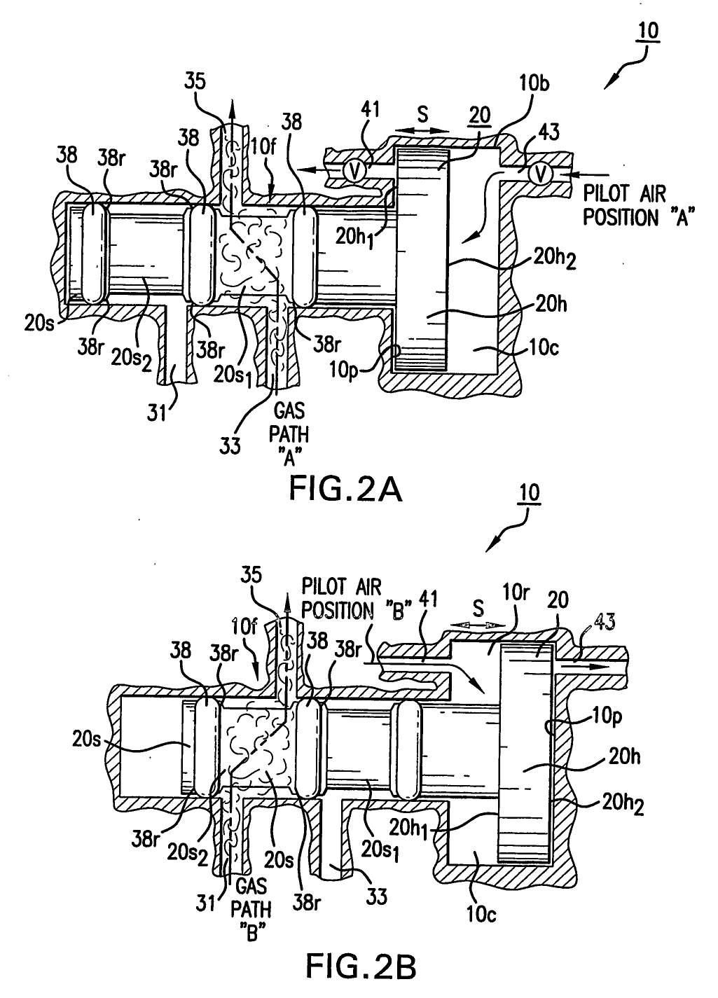

FIGS. 2A and 2B illustrate one embodiment of the gas delivery valve 10. The gas delivery valve 10 has a body 10b with passages that define at least one gas flow path (the gas flow path or paths referred to generally as feature 10f) and a receptacle 10r for a spool 20. Although shown as one spool and two different gas inlet ports (for Gas A and Gas B, respectively), multiple spools can be used in series and/or parallel to achieve different gas flow path options. In addition, the valve body and spool may be configured for an “on-off” operation of a single gas to deliver or hold back a single gas (typically hyperpolarized gas) and/or to open and close the single gas flow path (not shown) for controlled inhalation delivery to a subject. As will be discussed below, the gas delivery valve 10 can also be configured to select between inhale, exhale, and/or breath-hold ventilation operations.

Referring again to FIG. 2A, as shown, the spool 20 includes a head 20h and a stem segment 20s. The valve body receptacle 10r includes pilot gas ports 41, 43 each positioned on opposing sides of the spool head portion 10c of the receptacle 10r so as to be facing opposing sides of the spool head 20h₁, 20h₂, respectively. For ease of discussion, the term “pilot air” will be used instead of “pilot gas” in the description that follows. However, it is noted that although air is typically the pilot gas employed, other gases may be used to actuate the spool(s) as desired. Further, other fluids, including liquids, may also be used to actuate the spools in certain applications, although gas signals will typically provide faster transmissions.

In operation, pilot air is directed to enter either port 43 or 41 and, apply pressure to the respective face of the spool head 20h. Increasing and decreasing the pilot air pressure will adjust the speed (faster and slower, respectively). The pressure from the pilot air against the spool head 20h forces the spool 20 to translate away from the pilot air input port. The translation positions the spool stem 20s in different operative and/or inoperative locations in the valve body 10b. In operation, the spool 20 translates (back and forth) to open and close selected gas flow paths in response to pilot gas transmitted into the valve body cavity of the spool head. The receptacle 10r for the spool head 20h is sized and configured so that the head of the spool 20h can translate a desired stroke distance “S” to open and close one or more gas flow paths.

FIG. 2A illustrates the pilot air being directed into port 43 on the outer face of the spool head 20h₂ to force the spool 20 to travel its stroke length “S” to position the inner face of the spool head 20h₁ against the receptacle perimeter 10p. The stroke translation positions different portions of the stem 20s in fluid communication with the gas exit port 35. As shown, the stem 20s includes two gas path segments, 20s₁ and 20s₂, each sandwiched by seals 38. The seals 38 are sized and configured to reside in recesses 38r formed into the valve body at different locations along the spool travel path. The seals 38 may be 0-rings or other suitable sealant members, formed of a material that inhibits depolarization that can enclose opposing portions of the stem segments 20s₁, 20s₂ during engagement of the selected gas flow path. Other sealing arrangements can also be used, such as by configuring the valve body and the stem to sealably matably engage at desired positions as will be understood by one of skill in the art. In FIG. 2A, the spool 20 is in a position in which segment 20s₁ is located so that gas path entry port 33 is in fluid communication with exit port 35 to open gas path “A” to deliver gas A through the gas delivery valve 10. Either Gas path A or B is typically for supplying hyperpolarized gas (such as a hyperpolarized noble gas including, but not limited to, hyperpolarized ¹²⁹Xe or ³He).

FIG. 2B illustrates pilot air being directed into port 41 with the outer face of the spool head 20h₂ being translated to reside against the perimeter 10p of the valve body receptacle 10r. This movement positions stem segment 20s₂ proximate exit port 35 to allow port 31 to be in fluid communication with the gas exit port 35 across the spool stem 20s to open gas path B and close gas path A.

It is noted that, although shown in FIGS. 2A and 2B as having only two gas flow inlet ports (31, 33), other numbers of valve body gas ports can be used (one or three, four or more). Further, the stem 20s can be reconfigured to concurrently release gas A and gas B (combined), or to deliver other gases. Thus, additional valve ports can be added to allow porting in series or parallel. In addition, the spool head 20h may be configured to have other stroke patterns such that the spool head 20h surfaces are not required to stop against the perimeter 10p of the valve body receptacle to actuate desired gas flow paths 10f as will be understood by those of skill in the art.

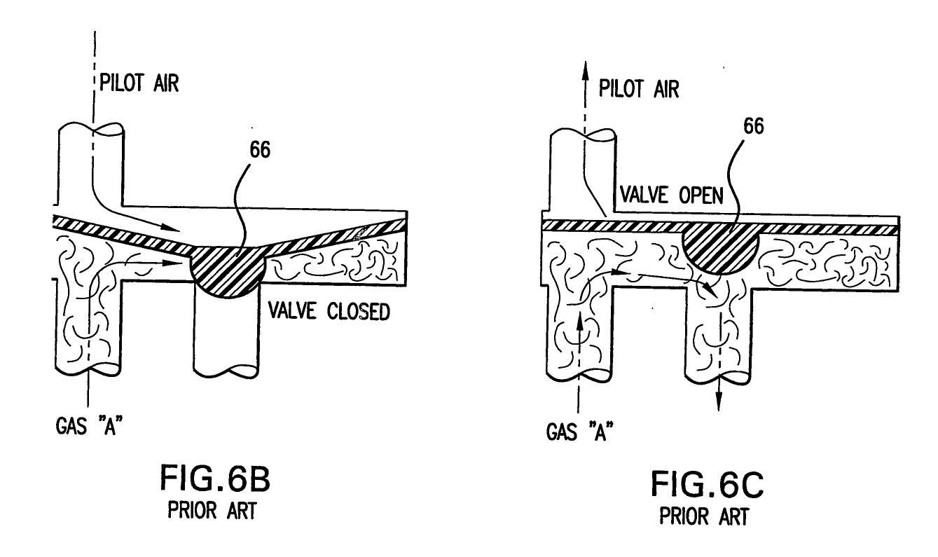

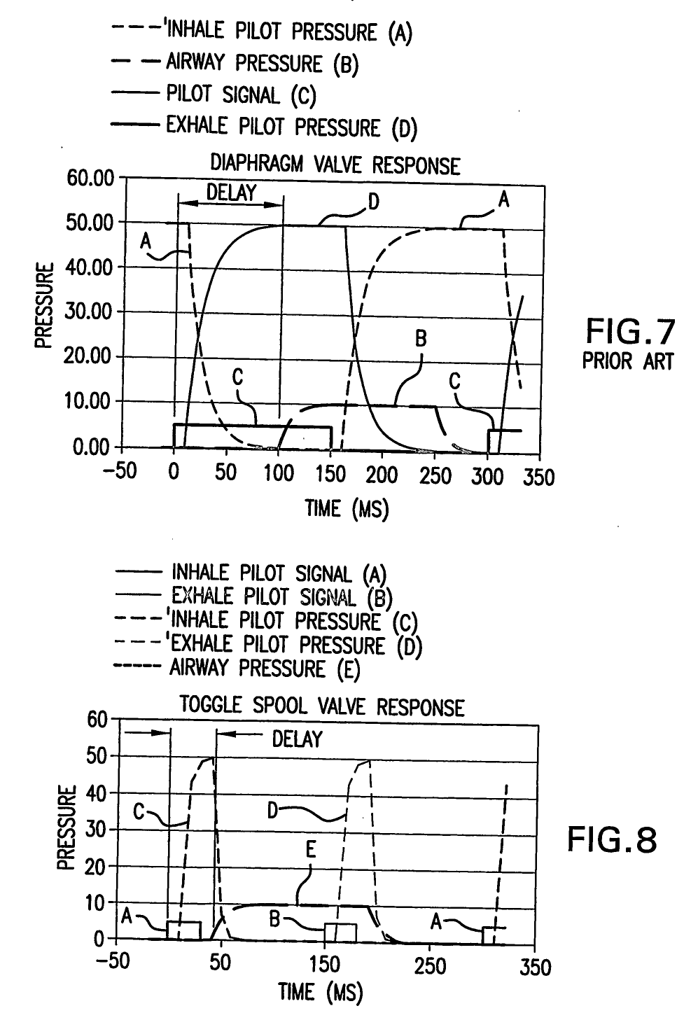

In certain embodiments, the spools are double acting spools that allow a single pulse of pilot air to actuate the valve to cause the spool 20 to move to the desired position and open or close the selected gas flow path. The pilot pressure can be released to atmosphere in between alternating pulses of pilot air to “toggle” the spool 20 from “inhale” to “exhale.” The spool actuation (back and forth) either opens and/or closes one or more gas paths. The actuation can occur during the steep rising edge of the pilot pressure curve as shown, for example, in FIG. 8. The rising edge operation is in contrast to conventional diaphragm 66 valve configurations (see, e.g., FIGS. 6A-6C) that typically actuate the diaphragm to move to its operative position late in the falling edge portion of the response curve. An exemplary diaphragm pressure response curve is shown in FIG. 7. Thus, the spool configuration pressure at which the spool actuates and the gas path opens and/or closes occurs earlier in the pressure response cycle than with the diaphragm valve.

FIG. 8 illustrates that the length or pulse duration of the pilot signal is typically less than about 30 ms, with the spool actuation delay being about 40 ms or less. The response delay can be the same for either inhale or exhale pilot signals. As shown, the inhale and exhale pilot pressure can be substantially the same. The spool actuation response is relatively quick (less than about 50 ms, and typically less than about 40 ms) and acts with less than half the delay associated with conventional diaphragm valve configurations as shown in FIG. 7. The spool can be actuated with a response pressure that is between about 30-60 psi.

The volume of the pilot air circuit can be sized for quick response by optimizing the volume, port diameters and the like to provide a reduced spool stroke cycle. In certain embodiments, the spool stroke can be about 0.125 inches, the pilot circuit volume can be about 0.00306 in³ per inch of tubing. For example for 180 inches of tubing line, the pilot circuit volume may be about 0.5508 in³. The pilot port diameters may be about 0.0625 inches. The spool head size may be about 0.625 inches (diameter). In certain embodiments, the spool head is sized to have an area of between about 0.05-0.45 in². The spool can be configured to weigh less than about 1 gram.

Referring back to FIG. 2A, the spool is operably associated with two pilot valves “V” (one in fluid communication with pilot-port 41 and the other in fluid communication with pilot port 43). The two pilot valves can be electric, three-way, normally closed solenoid valves. After the command pilot pulse signal is transmitted to the desired spool (or spools), typically with a pulse of between about 20-30 ms, but generally under about 40 ms, the normally closed pilot valve sending the command pilot pulse can be vented to atmosphere so that the command pilot pressure does not offer resistance to the opposing pilot air when it is actuated to drive the spool back to its former position. The dual acting spool configuration can be operated so that the pilot pressure is always on to provide a biasing mechanism to cause the spool 20 to return to a neutral or normal operating position after the pilot pulse signal is transmitted. The air is always directed to one side of the other to bias the location of the spool without requiring the use of a spring member. In other embodiments, a polarization friendly spring (formed of a resilient non-ferromagnetic metal or elastomeric material) can be used to help bias the spool to return to a desired position after transmission of the pilot command signal (not shown).

The valve body and its internal components can be formed from and/or coated with a material or materials selected for the ability to inhibit depolarization of hyperpolarized gas (such as due to relaxation attributed to gas interaction therewith). Coatings such as sol-gel coatings, deuterated polymer coatings, metal film coatings and other coatings and non-magnetic materials that inhibit depolarization have also been proposed. See, e.g., U.S. patent application Ser. No. 09/485,476 and U.S. Pat. Nos. 5,612,103 and 6,423,387, the contents of which are hereby incorporated by reference as if recited in full herein. For example, the valve body and/or components may be formed of materials such as, but not limited to, aluminum, TEDLAR, TEFLON, PTFE, DELRIN (acetal), and the like. Care should be taken to reduce the sources of friction by providing a smooth surface finish, and reducing the number of O-rings or selecting the O-ring material to reduce friction. In addition, the valve body can be fabricated to tolerances to provide sufficient seals and yet provide reduced friction between the spool and valve body receptacle. Thus, the valve body bore finishes, O-ring compression, and lubricants may all be considered to reduce the sources of friction.

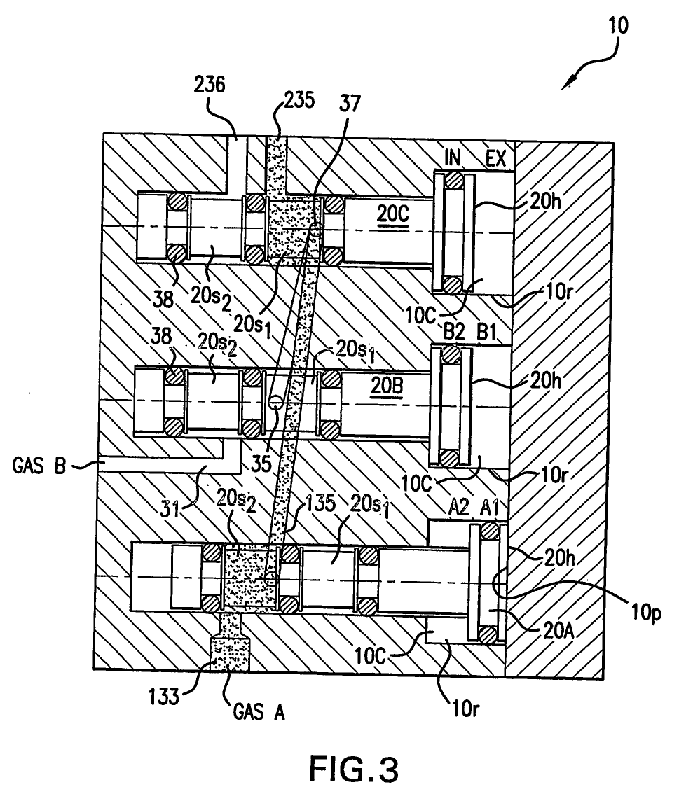

FIG. 3 illustrates a valve 10 having a valve body 10b that defines three spool receptacles 10r each for accommodating one of spools 20A, 20B, 20C, respectively. Control of the input of Gas A into the valve 10 is controlled by a first spool 20A that is positioned to control the gas port 133 that is in fluid communication with the external Gas A source. Valve body 10b defines a gas flowpath 135 extending in fluid communication between the spool receptacles for spools 20A and 20C while extending about the spool receptacle for spool 20B. Spool 20A has two operative positions, A1 and A2. In the A1 position shown (with the spool head 20h residing against perimeter 10p at the outermost portion of the spool cavity 10c), Gas A is allowed to travel from the spool receptacle for spool 20A, through flowpath 135 into the spool receptacle for spool 20C, and out the exit port 235. Valve body 10b defines exit port 235 for conducting gas to a subject for inhaling and from a subject on exhaling. Suitable gas conduits, not shown, are contemplated to carry the gases to and from the appropriate ports of valve 10.

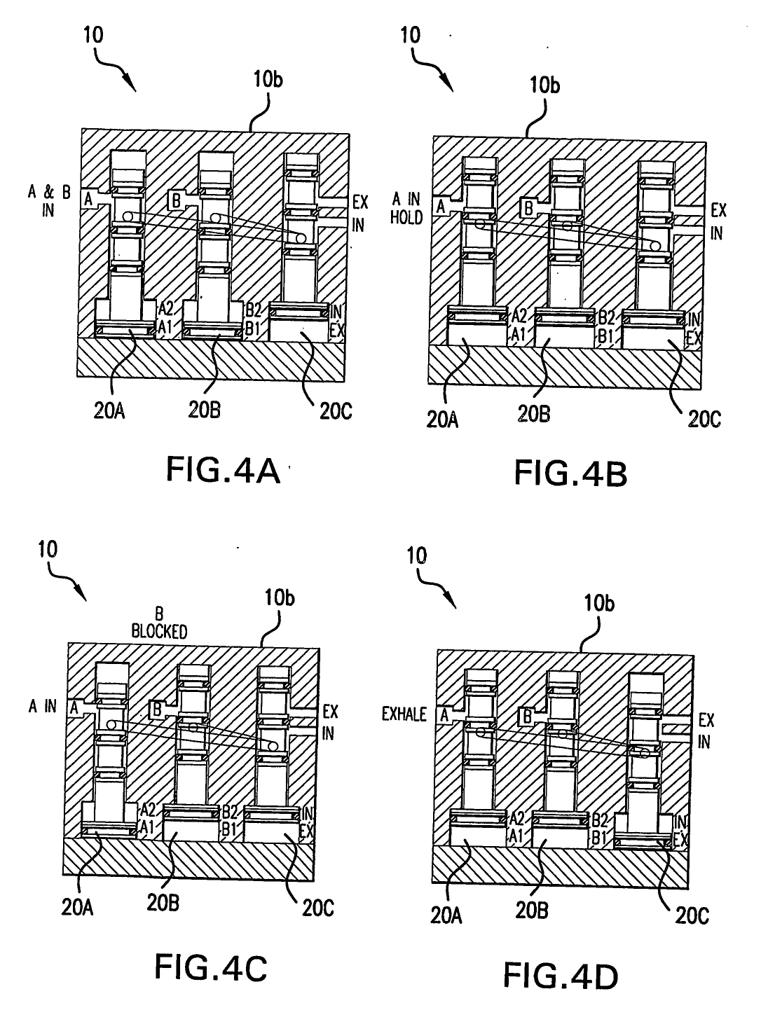

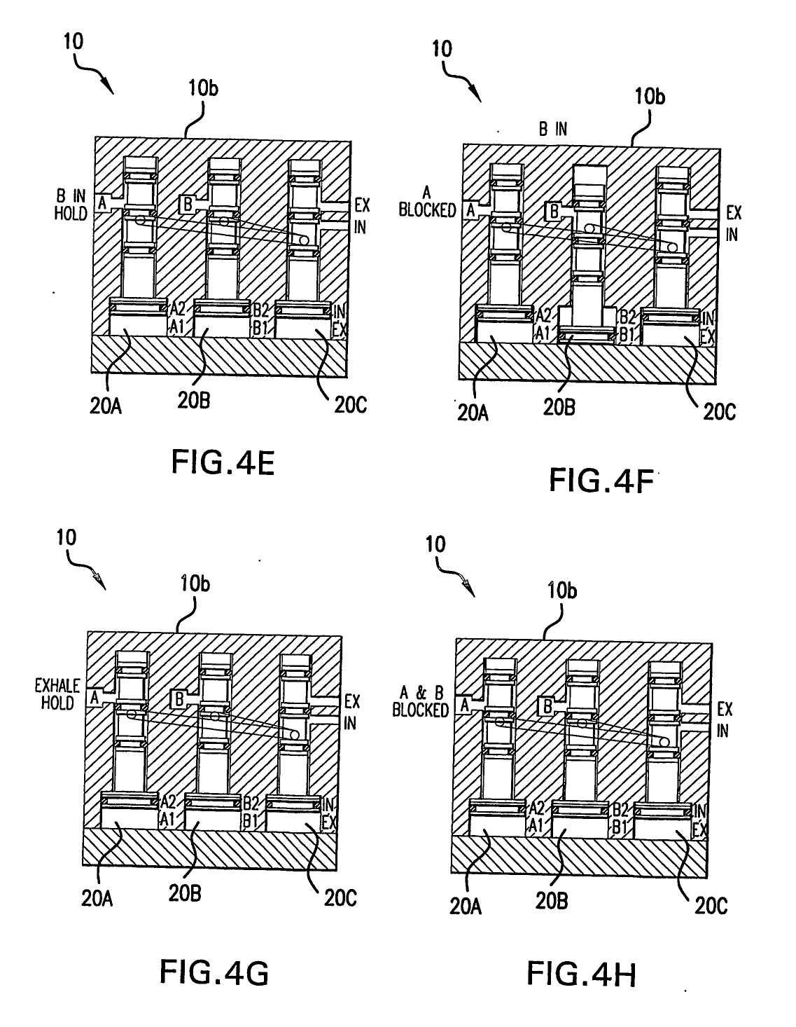

Similarly, the flow of Gas B from an external source and through the Gas B input port 31 to exit port 235 is controlled by the positioning of second spool 20B. The second spool 20B also has two operative positions, B1 and B2. Valve body 10b defines a second elongate flowpath 35 extending in fluid communication between the spool receptacle for spool 20B and an aperture 37 opening into the spool receptacle for spool 20C. Aperture 37 desirably is located opposite the open end of flowpath 135 from the spool receptacle for spool 20A, although they may be arranged differently, or even co-extensively. The positioning of the spool segments 20s₁, 2s₂ of spools 20A and 20B can be adjusted to allow Gas B to be output alone or combined with Gas A, as will be further described for FIGS. 4A-4H hereinbelow. The second spool 20B is shown in position B2 with the Gas B input port 31 isolated from flowpath 35 and Gas A allowed to pass all the way through to exit port 235. When spool 20B is in the BI position, Gas B will be able to travel through flowpath 35 and out exit port 235.

The third spool 20C is configured to control the inhale and exhale configuration of the valve 10. As such, the third spool 20C has an IN position and an EX position. The valve body 10b defines an exit ports 235 and 236 in fluid communication with the spool receptacle 10r for spool 20C. The position of the third spool 20C cooperates with the associated valve receptacle 10r to either direct flow from about spool segment 20s₂ and out exit port 235 when spool 20C is in the IN (or inhale) position, or from exit port 235, about spool segment 20s₁ and out exit port 236 when spool 20C is in the EX (or exhale) position, as desired. The gas flow path depicted in FIG. 3 is illustrated by the dark shading extending from Gas A input port 133 to the valve 10 exit inhale port 135 that is actuated to expel Gas A (alone) through the ventilation inhale port 135.

Whereas flowpaths 35 and 135, which are considered to extend outside the plane of the view depicted in FIG. 3 are depicted in FIG. 3, the preset invention contemplates that valve body 10b further defines pilot air ports (not shown) for directing air against either side of the spool heads for spools 20A, 20B, and 20C which are also located outside the plane of the view. These pilot air ports would be configured to incorporate the features of ports 41 and 43 described in FIGS. 2A and 2B. A pair of opposing pilot air ports desirably provide pilot air to the opposing faces of each spool head 20h. The valving for such ports are desirably located outside of valve body 10b, although such valves may be incorporated into valve body 10b as well. The present invention further contemplates that each spool may be acted upon by a single pilot air port which directs air against one face of each spool head 20h to move the spool in a first direction to its first position and draws air out of bore 10C for each spool to force the spool to travel the opposite direction to its second position. Alternatively, opposing pilot air ports may act in unison to actively force air into, or out of, bore 10C in order to urge the spool to the desired position.

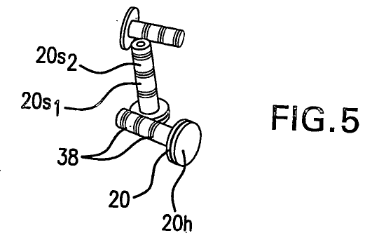

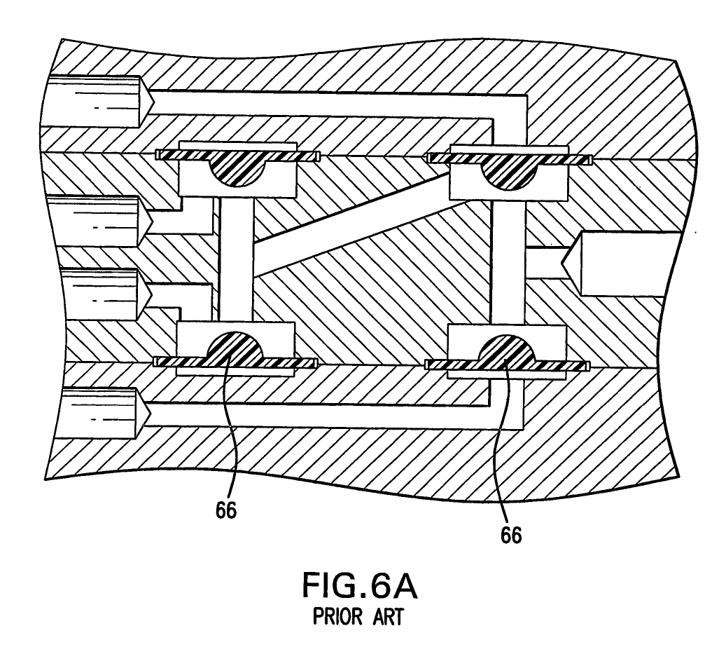

FIG. 5 depicts the three spools 20 of FIG. 3 specifically and of the present invention generally. FIG. 5 further illustrate spool segments 20s₁, 20s₂ of each spool 20, as well as spool head 20h and the gaskets 38 which sealingly engage the valve body 10b for directing flow therethrough.

FIGS. 4A-4H illustrate examples of different valve positions of a three-spool configuration that can be used to provide selection of ventilation breath outputs and/or inputs according to embodiments of the present invention. For discussion purposes, Gas A will be described as a hyperpolarized gas and Gas B as a non-polarized gas. In operation, a reverse configuration can be used. The term “breath-hold” means that the gas or gases are held in the lungs for a breath-hold time to facilitate bio-uptake of the gas an/or allow a stronger hyperpolarized gas signal other normal respiration. The breath-hold duration may be between 5-30 seconds.

As shown and further described below, the valve 10 can be actuated to accommodate or provide (a) Gas “A” inhale; (b) Gas “B” inhale; (c) Gas “A”+Gas “B” inhale; (d) exhale; (e) partial exhale and breath hold; (f) Gas “A” inhale and breath hold; (g) Gas “B” inhale and hold; and (h) Gas “A”+Gas “B” inhale and breath hold. The valve spool configuration can be adjusted to provide all or selected ones of these ventilation breath inputs/outputs and may use lesser or greater numbers of spools and/or respective spool segments as well as different porting configurations to provide the desired breath outputs/inputs.

FIG. 4A illustrates the operative position of the three spools to provide Gas “A”+Gas “B” inhale. FIG. 4B illustrates Gas “A” output in an inhale breath-hold position. FIG. 4C shows the positions of the spools for Gas “A” inhale. FIG. 4D shows the spool positions for exhale; FIG. 4E shows the spools in position for Gas “B” inhale and hold. FIG. 4F shows the positions of the spools for Gas “A” blocked and FIG. 4G shows an exhale hold configuration. FIG. 4H illustrates a Gas “A”+Gas “B” hold configuration.

The valve spool positions and sequencing of operation can be automated and controlled by a computer control program. The actuation or piloting of the valve spools 20A, 20B, 20C, can be driven through the computer control program by six (6) electric three-way normally closed solenoid valves. Examples of suitable solenoid valves include, Clippard EC-#M-12V, Cincinnati, Ohio., and MAC 42A-AMP-000-GDDB-1BE, Wixom, Mich. In certain embodiments, a command is given to actuate an individual spool to a desired position. The command triggers the transmission of a 20-30 ms pilot command pulse signal to the individual spool. The single command pulse toggles the spool to the desired position. After the pulse, the normally closed solenoid valve vents to atmosphere so that the pilot pressure for that spool does not generate undue resistance to the opposing pilot gas (air) when it is actuated to drive the spool back to its previous position.

The hyperpolarized gas may be a hyperpolarized noble gas such as ³He and/or ¹²⁹Xe. The non-polarized gas may be a mixture of non-polarized gases. The non-polarized gas can be selected to inhibit depolarization of the hyperpolarized gas, and may be also selected for biocompatibility. Examples of suitable non-polarized gases include, but are not limited to, nitrogen, xenon, and helium.

The valve body 10b (FIG. 4) can be configured to hold a plurality of individually operable spools in close proximity. The valve spools or translating components may be configured so that the centerlines of adjacent receptacles are less than 1 inch apart, and, in certain embodiments, are about 0.5 inches apart. During operation, the valve can be configured to reduce the number of breath cycles that are required for switching between gases output to a subject. In addition, the spool configuration is such that dead volume for the inhaled gas(es) can be reduced. Dead volume is the volume within the valve that needs to be filled with gas before the gas will reach the subject. The smaller the volume, the less gas is “wasted” inside the valve. Reducing the dead volume is particularly desirable when dispensing hyperpolarized gas because the hyperpolarized gas fills the volume of the flow path from source to subject and any polarized gas remaining in the dead volume may become unpolarized or decay to an undesirable polarization level, and must be displaced before suitably polarized gas can reach the subject on the next polarized breath. In certain embodiments, the dead volume for the gas delivery valve can be about 0.445 ml. In particular embodiments, the dead volume may be even less, such as on the order of about 0.223 ml.

As will be appreciated by one of skill in the art, the present invention may be embodied as a method, data or signal processing system, or computer program product. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, or magnetic storage devices.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Computer program code for carrying out operations of the present invention may be written in an object oriented programming language such as Java7, Smalltalk, Python, or C++. However, the computer program code for carrying out operations of the present invention may also be written in conventional procedural programming languages, such as the “C” programming language or even assembly language. The program code may execute entirely on the user's computer, partly on the user's computer, as a stand-alone software package, partly on the user=s computer and partly on a remote computer or entirely on the remote computer. In the latter scenario, the remote computer may be connected to the user=s computer through a local area network (LAN) or a wide area network (WAN), or the connection may be made to an external computer (for example, through the Internet using an Internet Service Provider).

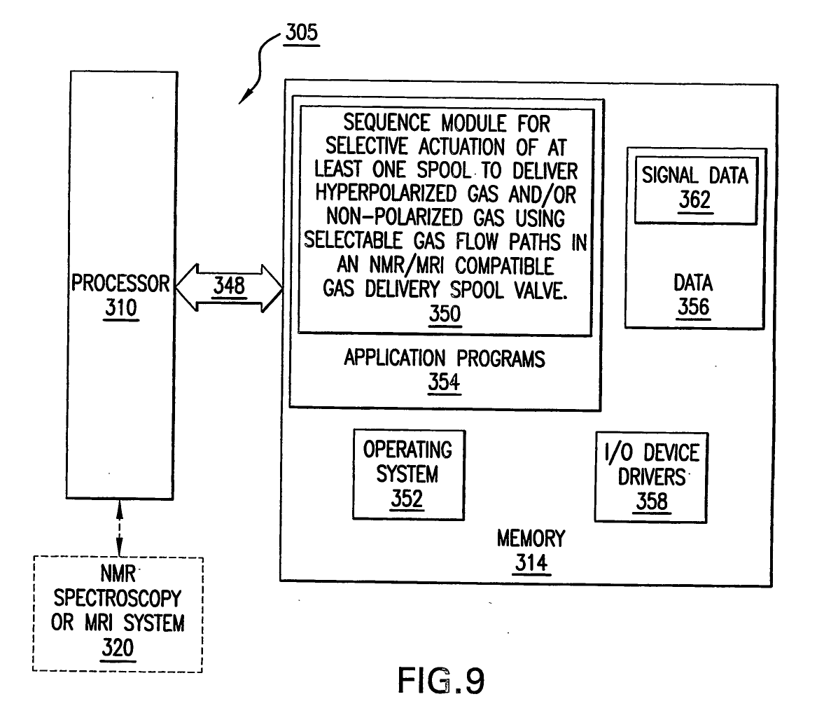

FIG. 9 is a block diagram of exemplary embodiments of data processing systems that illustrates systems, methods, and computer program products in accordance with embodiments of the present invention. The processor 310 communicates with the memory 314 via an address/data bus 348. The processor 310 can be any commercially available or custom microprocessor. The memory 314 is representative of the overall hierarchy of memory devices containing the software and data used to implement the functionality of the data processing system 305. The memory 314 can include, but is not limited to, the following types of devices: cache, ROM, PROM, EPROM, EEPROM, flash memory, SRAM, and DRAM.

As shown in FIG. 9, the memory 314 may include several categories of software and data used in the data processing system 305: the operating system 352; the application programs 354; the input/output (I/O) device drivers 358; a Remote Control Sequence Module for selective actuation of spools 350; and the data 356. The data 356 may include ventilation operation data 362 which may be obtained from a ventilation system and/or may be NMR or MRI data from an NMR spectroscopy or MRI system 320. The valve 10 may be particularly suitable for NMR/MRI procedures of hyperpolarized gas ventilation delivery. As will be appreciated by those of skill in the art, the operating system 352 may be any operating system suitable for use with a data processing system, such as OS/2, AIX or OS/390 from International Business Machines Corporation, Armonk, N.Y., WindowsXP, WindowsCE, WindowsNT, Windows95, Windows98 or Windows2000 from Microsoft Corporation, Redmond, Wash., PalmOS from Palm, Inc., MacOS from Apple Computer, UNIX, FreeBSD, or Linux, proprietary operating systems or dedicated operating systems, for example, for embedded data processing systems.

The I/O device drivers 358 typically include software routines accessed through the operating system 352 by the application programs 354 to communicate with devices such as I/O data port(s), data storage 356 and certain memory 314 components and/or the image acquisition system 320. The application programs 354 are illustrative of the programs that implement the various features of the data processing system 305 and preferably include at least one application that supports operations according to embodiments of the present invention. Finally, the data 356 represents the static and dynamic data used by the application programs 354, the operating system 352, the I/O device drivers 358, and other software programs that may reside in the memory 314.

While the present invention is illustrated, for example, with reference to the Sequence Module 350 for selective actuation of spools in a gas delivery valve being an application program in FIG. 9, as will be appreciated by those of skill in the art, other configurations may also be utilized while still benefiting from the teachings of the present invention. For example, the Sequence Module 350 may also be incorporated into the operating system 352, the I/O device drivers 358 or other such logical division of the data processing system 305. Thus, the present invention should not be construed as limited to the configuration of FIG. 9, which is intended to encompass any configuration capable of carrying out the operations described herein.

In certain embodiments, the Sequence Module 350 includes computer program code for timing the delivery of the desired inhalation gas(es) and may include code for tracking polarization level data of the dispensed hyperpolarized gas. The Module 350 can direct initiation of operations that will automatically sequence the spools to output at a desired breath per minute rate and may automatically adjust the rate based on sensed activity of the ventilated subject or upon clinician input by increasing or decreasing the pressure of the pilot command pulse signal.

The I/O data port can be used to transfer information between the data processing system 305 and the NMR data acquisition system 320 or another computer system, a network (e.g., the Internet) or other device controlled by the processor. These components may be conventional components such as those used in many conventional data processing systems, which may be configured in accordance with the present invention to operate as described herein.

While the present invention is illustrated, for example, with reference to particular divisions of programs, functions and memories, the present invention should not be construed as limited to such logical divisions. Thus, the present invention should not be construed as limited to the configuration of FIG. 9 but is intended to encompass any configuration capable of carrying out the operations described herein.

The flowcharts and block diagrams of certain of the figures herein illustrate the architecture, functionality, and operation of possible implementations of probe cell estimation means according to the present invention. In this regard, each block in the flow charts or block diagrams represents a module, segment, or portion of code, which comprises one or more executable instructions for implementing the specified logical function(s). Certain of the flowcharts and block diagrams illustrate methods to operate hyperpolarizers or components thereof to yield polarized gas according to embodiments of the present invention. In this regard, each block in the flow charts or block diagrams represents a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order, depending upon the functionality involved.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A gas delivery valve for a ventilator configured to supply hyperpolarized gas to a subject, the gas delivery valve comprising:
a valve body having at least one gas flow path extending between at least one gas inlet port and at least one gas exit port and at least one spool receptacle, one of the at least one gas inlet ports being in fluid communication with a hyperpolarized gas source;
at least one spool member disposed in a respective one of said at least one spool receptacles of said valve body, said spool member configured and sized to cooperate with said valve body to selectively open and close the at least one gas flow path; and
at least one pilot fluid port in fluid communication with said spool receptacle,
wherein, in operation, a pilot fluid command pulse signal having an associated pressure and duration is transmitted into said pilot fluid port thereby forcing said spool to translate an actuation distance in a predetermined direction in said valve body receptacle to open and/or close the at least one gas flow path.

2. A gas delivery valve according to claim 1, wherein the valve body has a plurality of controllably selectable different gas flow paths therein, each having an associated gas inlet port, one of said gas inlet ports being in fluid communication with the hyperpolarized gas source and a different one of said gas inlet ports being in fluid communication with a non-polarized gas source, wherein the spool member comprises a plurality of spaced apart stem segments with a seal member disposed therebetween, and wherein the position of the spool in the valve body aligns a respective one of the stem segments with a respective one of the gas inlet ports and the gas exit port to open a respective gas flow path to deliver the hyperpolarized gas or the non-polarized gas provided from the aligned gas inlet port to the gas exit port to a subject.

3. A gas delivery valve according to claim 1, wherein the spool comprises a spool head and an elongated stem.

4. A gas delivery valve according to claim 3, wherein the spool receptacle in the valve body includes a spool head portion that has an axial length that is longer than the spool head, and wherein the length of the receptacle spool head portion defines the stroke actuation translation distance of the spool.

5. A gas delivery valve according to claim 4, wherein the at least one pilot fluid port is two fluid pilot ports, each positioned on opposing sides of the spool receptacle portion so as to be proximate a respective one of the major surfaces of the spool head during operation.

6. A gas delivery valve according to claim 5, wherein the pilot fluid ports are pilot gas ports, said valve further comprising a pilot gas source configured to provide a pilot command pulse signal having a duration that is less than about 40 ms.

7. A gas delivery valve according to claim 6, wherein the pilot command pulse signal generates a spool pressure response profile that has a delay measured from the start of the pilot command pulse signal to the maxima of the pressure response profile that is less than about 50 ms.

8. A gas delivery valve according to claim 7, wherein the spool pressure response profile has a rising initial portion that rises to between about 30-60 psi.

9. A gas delivery valve according to claim 8, wherein, in operation, the spool travels the stroke actuation distance in the valve body in response to the rising initial portion of the spool pressure response profile.

10. A gas delivery valve according to claim 1, wherein at least one gas flow path of the valve body is a plurality of different gas flow paths, wherein the valve body comprises a plurality of spaced apart spool receptacles and a corresponding number of spools, each spool receptacle comprising two pilot ports in fluid communication with a pilot gas source, and wherein respective spools are configured to selectively open and close gas flow paths in the valve body in response to pilot command pulse signals transmitted thereto so as to controllably serially or concurrently output a plurality of different gases from the gas delivery valve.

11. A gas delivery valve according to claim 10, wherein the valve is able to operate so as to accommodate up to about a 150 breath per minute ventilation rate.

12. A gas delivery valve according to claim 10, wherein the valve is able to operate so as to accommodate up to about a 180 breath per minute ventilation rate.

13. A gas delivery valve according to claim 10, wherein the valve is able to operate so as to accommodate up above about a 200 breath per minute ventilation rate.

14. A gas delivery valve according to claim 10, wherein the valve body and spool members are configured to provide gas flow paths for ventilation breath inhale inputs and/or receive exhale outputs of at least: (a) hyperpolarized Gas A inhale; (b) exhale; (c) hyperpolarized Gas A inhale and hold.

15. A gas delivery valve according to claim 10, wherein the valve body and spool members are configured to provide ventilation breath inhale inputs and/or receive exhale outputs of at least: (a) hyperpolarized Gas A inhale; (b) non-polarized Gas B inhale; (c) a combination of hyperpolarized Gas A and non-polarized Gas B inhale; (d) exhale; (e) partial exhale and hold; (f) hyperpolarized Gas A inhale and hold; (g) Gas B inhale and hold; and (h) a combination of hyperpolarized Gas A and Gas B inhale and hold.

16. A gas delivery valve according to claim 10, wherein the plurality of spools is three spools.

17. A gas delivery valve according to claim 16, wherein the three spools are in fluid communication with each other, and wherein the gas path exit port is a common inhale port used to deliver selected gas from the valve.

18. A gas delivery valve according to claim 17, wherein the valve further comprises an exhale port configured to expel exhale breaths.

19. A gas delivery valve according to claim 10, wherein the valve body comprises an exhale port proximate the exit port, wherein the plurality of receptacles and spools includes, a first receptacle and a corresponding first spool disposed proximate the exhale port and the exit port, a second receptacle and second spool spaced apart from and in fluid communication with the first spool, the second receptacle having gas inlet port B to supply non-polarized Gas B during operation, and a third receptacle and third spool spaced apart from the first and second spools and in fluid communication with the second spool, the third receptacle having gas inlet port A to supply hyperpolarized Gas A during operation, and wherein the gas inlet port to the first receptacle is either or both the exit ports from the second and third receptacles.

20. A gas delivery valve according to claim 1, wherein the hyperpolarized gas source contains hyperpolarized ³He.

21. A gas delivery valve according to claim 1, wherein the hyperpolarized gas source contains hyperpolarized ¹²⁹Xe.

22. A gas delivery valve according to claim 10, wherein the gas flow paths comprise a first inhale gas flow path, a second exhale gas flow path, and a third breath-hold gas flow path, each of which are remotely selectable gas flow paths.

23. A gas delivery valve according to claim 22, wherein the spools and valve body are arranged to allow hyperpolarized gas, non-polarized gas, or a combination of the hyperpolarized gas and non-polarized gas, to be output from the inhale and/or breath-hold gas flow paths.

24. A gas delivery valve according to claim 6, wherein the spool reciprocates between first and second operative positions, said valve further comprising two normally closed solenoid valves, one operably associated with each of the pilot fluid ports and the pilot gas source, the solenoid valves configured to control the actuation of the spool between the first and second positions, wherein, in operation, after a command pilot pulse signal is transmitted to a spool head via a selected one of the pilot ports to force the spool to translate to the second position from the first position, the respective normally closed pilot valve associated with the selected pilot port vents to atmosphere so that pilot pressure in the spool head receptacle portion is reduced to inhibit interference with the opposing pilot gas signal from the other pilot port when the valve spool is actuated to drive the spool back to its first position.

25. A gas delivery valve according to claim 24, further comprising a computer module with computer program code that remotely controls the sequence of pilot command signals to respective spools to actuate the spools and automatically open and close desired gas flow paths in the valve body to ventilate with the desired sequence of hyperpolarized gas and non-polarized gas.

26. A gas delivery valve according to claim 1, wherein the valve is fabricated from and/or coated with a material that inhibits depolarization of the hyperpolarized gas.

27. A gas delivery valve according to claim 26, wherein the valve body is aluminum.

28. A gas delivery valve according to claim 19, further comprising a plurality of conduits outwardly extending from the valve body to define a plurality of gas flow paths, the plurality of conduits including two pilot gas flow path conduits for each spool head receptacle portion in the valve body, at least one hyperpolarized gas conduit extending from the hyperpolarized gas source to a corresponding gas inlet port in the valve body, and at least one non-polarized gas conduit extending from a non-polarized gas source to a corresponding gas inlet port in the valve body.

29. A gas delivery valve according to claim 28, wherein the spool head has an area of between about 0.05-0.45 in².

30. A gas delivery valve according to claim 28, wherein the volume of the pilot gas command signal flow path is sized to be on the order of about 0.00306 in³ per inch of pilot gas command conduit line length.

31. A gas delivery valve according to claim 1, wherein the valve is configured and sized for small animal ventilation.

32. A method for delivering hyperpolarized gas to a subject, comprising:
providing a gas delivery valve with at least one gas flow path therein, the valve comprising a valve body and at least one spool held in the valve body;
transmitting a pilot command fluid pulse signal to the at least one spool to introduce pressure onto the spool to force the spool to translate an actuation distance in the valve body; and
opening and/or closing the at least one gas flow path based on the position of the spool in the valve body in response to the transmitted signal to deliver hyperpolarized gas to a subject.

33. A method according to claim 32, wherein the spool comprises a spool head and a spool stem, and the valve body comprises a spool receptacle with a spool head cavity, wherein, in operation, the spool is configured to slidably reciprocate in the spool receptacle so that the spool head travels to contact opposing first and second sides of the spool head cavity, the first side when in a first actuation position and the second side when in a second actuation position, which reciprocation positions the spool stem in different operative positions.

34. A method according to claim 33, wherein the spool stem comprises first and second segments, each separated by a sealing member positioned about a perimeter of the spool stem, wherein, in the first actuation position the first segment is in fluid communication with a gas inhale exit port and a first gas inlet port in the valve body to define a first gas flow path, and wherein, in the second actuation position, the second segment is in fluid communication with the gas inhale exit port and a second gas inlet port in the valve body.

35. A method according to claim 32, wherein the transmitting step is carried out to provide a pilot command gas pulse signal having a duration that is between about 10-40 ms.

36. A method according to claim 32, wherein the transmitting step is carried out to provide a pilot command gas pulse signal having a duration that is between about 20-30 ms.

37. A method according to claim 32, further comprising generating a spool pressure response profile based on the transmitted signal, wherein the spool pressure response profile has a delay measured from the start of the transmitted pulse signal to the maxima of the response profile that is less than about 40 ms, and wherein the spool pressure response profile has a peak pressure that is below about 60 psi.

38. A method according to claim 37, wherein the spool is actuated during a rising portion of the pressure response profile.

39. A method according to claim 33, further comprising repeating said transmitting and opening and/or closing steps and venting the pilot gas in the valve to atmosphere before repeating the transmitting step.

40. A method according to claim 32, wherein the spool is actuated based on a single transmitted pilot command pulse signal.

41. A method according to claim 32, wherein the gas delivery valve has a plurality of selectable gas flow paths therein, including an inhale path, an exhale path, and a breath-hold path, wherein the valve body comprises a plurality of spools, wherein the transmitting step is carried out to individually transmit the pilot command gas signal to each respective spool to force the spools to translate an actuation distance in the valve body, and wherein the opening and/or closing of the gas flow paths is automatically carried out in response to the transmitted signals.

42. A method according to claim 41, wherein the gas delivery valve is configured to accommodate up to about a 200 breaths per minute rate at peak inspiration.

43. A method according to claim 41, wherein the gas delivery valve is configured to accommodate up to about a 10 breaths per minute rate at peak inspiration.

44. A method according to claim 41, wherein the gas delivery valve is configured to selectively deliver hyperpolarized gas alone, non-polarized gas alone, and/or hyperpolarized gas combined with non-polarized gas in the valve body.

45. A method according to claim 32, wherein the transmitting and opening and/or closing steps are carried out during an NMR spectroscopy and/or MRI imaging session.

46. A method according to claim 32, wherein the valve is configured for small animal ventilation.

47. A method according to claim 32, further comprising adjusting the translation speed of the spool by increasing and/or decreasing the pressure of the transmitted pilot command pulse signal.

48. A method according to claim 32, wherein the hyperpolarized gas comprises hyperpolarized ¹²⁹Xe.

49. A method according to claim 32, wherein the hyperpolarized gas comprises hyperpolarized ³He.

50. A computer program product for delivering hyperpolarized gas using a ventilator and an associated gas delivery valve defining a plurality of selectable gas flow paths using a plurality of individually actuatable spools held in the valve, each spool positioned in the valve so that it is in fluid communication with at least one respective pilot gas port, the computer program product comprising:
a computer readable storage medium having computer readable program code embodied in said medium, said computer-readable program code comprising:
computer readable program code that determines which gas formulation is to be delivered by the gas delivery valve for inhalation by the subject, the gas selection includes at least one hyperpolarized gas, at least one non-polarized gas, and a combined hyperpolarized gas and non-polarized gas mixture;
computer readable program code that determines whether to configure the gas delivery valve for inhale, exhale, or breath hold operation; and
computer readable program code that transmits a pilot command pulse signal to each spool to actuate the respective spool to a desired operative position in the valve body to thereby open and/or close the desired gas flow paths and deliver the desired gas therethrough.

51. A computer program product according to claim 50, wherein the spool includes a spool head and an elongate spool stem, wherein the valve includes two pilot ports for each spool positioned in the valve body so that the two ports face each other with the spool head positioned intermediate thereof, each pilot port operably associated with a respective normally closed solenoid, and wherein said computer program product further comprises computer readable program code that determines which pilot air port to transmit the pilot command signal through to force the spool to travel in a desired actuation direction.

52. A computer program product according to claim 50, further comprising computer readable program code that actuates the valve spools to select ventilation operation between at least: (a) hyperpolarized gas inhale; (b) exhale; (c) hyperpolarized gas inhale and hold.

53. A computer program product according to claim 50, further comprising computer readable program code that controllably actuates the valve spools to select ventilation operation between at least: (a) hyperpolarized gas inhale; (b) non-polarized gas inhale; (c) a combination of hyperpolarized gas and non-polarized gas inhale; (d) exhale; (e) partial exhale and hold; (f) hyperpolarized gas inhale and hold; (g) non-polarized gas inhale and hold; and (h) a combination of hyperpolarized gas and non-polarized gas inhale and hold.

54. A computer program product according to claim 50, further comprising computer readable program code for increasing and/or decreasing the pressure of the command pilot signal pulse to thereby increase or decrease the response actuation time of the spools.

55. A computer program product according to claim 52, further comprising computer readable program code that actuates the spools in a manner that allows pilot pressure to be released to atmosphere from the valve body proximate each spool between alternating pulses of pilot gas to thereby switch from inhale to exhale gas flow paths.

56. A computer program product according to claim 54, wherein the computer program code automatically adjusts its rate to accommodate up to at least a 150 breath per minute rate at peak inspiration.

57. A computer program product according to claim 54, wherein the computer program code automatically adjusts its rate to accommodate up to at least about a 180 breath per minute rate at peak inspiration.

58. A computer program product according to claim 54, wherein the computer program code automatically adjusts its rate to accommodate up to at least about a 200 breath per minute rate at peak inspiration.

59. A computer program product according to claim 50, wherein the hyperpolarized gas is a hyperpolarized noble gas, and wherein the non-polarized gas is a selected biocompatible non-polarized gas that inhibits depolarization of the hyperpolarized gas.

60. A computer program product according to claim 50, wherein the computer readable program code that transmits a pilot command pulse signal to each spool to actuate the respective spool to a desired operative position in the valve body directs a pilot gas source to transmit a pilot command pulse signal having a duration that is less than about 40 ms and a pressure that is less than about 60 psi.

61. A computer program product according to claim 60, wherein the computer program code directs the pilot source to transmit a pilot command gas pulse signal having a duration that is between about 20-30 ms.

62. A computer program product according to claim 60, wherein the spools actuate in less than 40 ms from the beginning of the transmitted pilot gas pulse signal.

63. An apparatus for delivering hyperpolarized gas to a ventilated subject, comprising:
a gas delivery valve with at least one gas flow path therein, the valve comprising a valve body and at least one spool held in the valve body;
means for transmitting a pilot command fluid pulse signal to the at least one spool to introduce pressure onto the spool to force the spool to translate an actuation distance in the valve body; and
means for opening and/or closing the at least one gas flow path based on the position of the spool in the valve body in response to the transmitted signal to deliver hyperpolarized gas to a subject.

64. An apparatus according to claim 63, wherein the spool comprises a spool head and a spool stem, and the valve body comprises a spool receptacle with a spool head cavity, wherein, in operation, the spool is configured to reciprocate in the spool receptacle so that the spool head travels to contact opposing first and second sides of the spool head cavity, the first side when in a first actuation position and the second side when in a second actuation position, which reciprocation positions the spool stem in different operative positions.

65. An apparatus according to claim 64, wherein the spool stem comprises first and second segments, each separated by a sealing member positioned about a perimeter of the spool stem, wherein, in the first actuation position the first segment is in fluid communication with a gas inhale exit port and a first gas inlet port in the valve body to define a first gas flow path, and wherein, in the second actuation position, the second segment is in fluid communication with the gas inhale exit port and a second gas inlet port in the valve body.

66. An apparatus according to claim 63, wherein the means for transmitting is configured to provide a pilot command gas pulse signal having a duration that is between about 10-40 ms.

67. An apparatus according to claim 63, wherein the spool is held in the valve so that in response to a transmitted pilot command signal, the spool generates a spool pressure response profile based on the transmitted signal, wherein the spool pressure response profile has a delay measured from the start of the transmitted pulse signal to the maxima of the response profile that is less than about 40 ms, and wherein the spool is actuated during the rising portion of the pressure response profile.
